(19) United States
(12) Patent Application Publication
(10) Pub. No.: US 2025/0362635 A1
(43) Pub. Date: Nov. 27, 2025

(54) IMAGE FORMING APPARATUS

(71) Applicant: Konica Minolta, Inc., Tokyo (JP)

(72) Inventor: Sho OKUZAWA, Tokyo (JP)

(21) Appl. No.: 19/216,901

(22) Filed: May 23, 2025

(30) Foreign Application Priority Data
May 27, 2024 (JP) 2024-085708

(51) Int. Cl. G03G 15/00; G03G 15/20

(52) U.S. Cl. CPC G03G 15/6564; G03G 15/2017; G03G 15/2064; G03G 15/5029; G03G 15/6517; G03G 2215/00746

(57) ABSTRACT

An image forming apparatus according to the present disclosure includes: a conveyer; an eye mark detector disposed in a conveyance path and detecting an eye mark formed on a sheet in advance; an image former forming an overprint image at a predetermined position on the sheet with reference to a position of the eye mark on the sheet; and a speed detector including a speed detection roller to be brought into contact with the sheet and detecting a conveyance speed of the sheet. The eye mark detector is disposed at a position separated by an integral multiple of a roller circumferential length of a driving roller and also by a non-integral multiple of a roller circumferential length of the roller from a position at which the image former forms the overprint image on the sheet.

### CROSS REFERENCE TO RELATED APPLICATIONS

The present invention claims priority under 35 U.S.C. § 119 to Japanese Patent Application No. 2024-85708 filed on May 27, 2024, the entire content of which is incorporated herein by reference.

### BACKGROUND

### Technological Field

The present disclosure relates to an image forming apparatus.

### Description of Related Art

Conventionally, there has been known an image forming apparatus that performs additional printing called overprint printing on a sheet on which a base image has been printed in advance.

FIG. 1 and FIG. 2 illustrate aspects of the overprint printing. In FIG. 1, examples of the eye mark Ra, the base image Rs, and the overprint image Rt formed on the continuous sheet P are illustrated. FIG. 2 illustrates a mode in which the overprint printing is performed on continuous sheet P in electrophotography printing.

The overprint printing is applied to, for example, a continuous sheet. In overprint printing, for example, after a base image is formed on the surface of a continuous sheet by analog printing such as screen printing, an overprint image is further formed on the surface of the continuous sheet by digital printing such as electrophotographic printing.

The base image and the overprint image are aligned with each other so that a well-balanced entire image is formed by the base image and the overprint image. Specifically, a reference mark called an eye mark is printed on the continuous sheet when the base image is formed. Then, an overprint image is formed at a position separated by a predetermined distance from the eye mark on the continuous sheet by overprint printing.

Conventionally, as illustrated in FIG. 2, an image forming apparatus applied to this type of overprint printing is provided with an eye mark detector for detecting an eye mark formed on a sheet. Then, the image forming apparatus determines the position at which the overprint image is formed on the sheet based on the sheet conveyance time after the eye mark is detected by the eye mark detector. Note that hereinafter, the position at which the overprint image is formed on the sheet in the image former is also referred to as an “image transfer point”.

However, in this type of image forming apparatus, there is a case where a variation occurs in the sheet conveyance time from the detection of the eye mark to the image transfer point. In such a case, the transfer timing does not match the timing at which the sheet is conveyed to the target position, and a shift occurs between the formation position of the base image and the formation position of the overprint image. In particular, in an image forming apparatus employing an intermediate transfer belt system for electrophotographic printing, image writing on a photoreceptor, image transfer from the photoreceptor to the intermediate transfer belt, and image transfer from the intermediate transfer belt to a sheet are performed after eye mark detection. Therefore, a sheet conveyance time from detection of the eye marks to an image transfer point is also long, and variations are likely to occur in the sheet conveyance time.

In view of such a background, in an image forming apparatus according to a conventional technology, a configuration has been proposed in which a sheet conveyance speed is detected and a rotation speed of a driving roller of a conveyer that conveys a sheet is subjected to feedback control in order to suppress, the speed fluctuation of a sheet conveyance time. See, e.g., Japanese Unexamined Patent Publication No. 2020-99996.

However, in the image forming apparatus according to the conventional technology, factors of sheet conveyance time, and speed fluctuation cannot be sufficiently analyzed, and measures for each of the factors are insufficient. As a result, depending on the situation, a large positional deviation occurs between the overprint image and the base image formed on a sheet. In such a case, the printed matter itself printed on the continuous sheet is treated as a defective product.

### SUMMARY

The present invention has been made in view of the above-mentioned problems. That is, an object of the present invention is to provide an image forming apparatus capable of suppressing the occurrence of the positional deviation between an overprint image and a base image to be formed on a sheet in overprint printing.

The main invention for solving the above-described problem is the following image forming apparatus.

An image forming apparatus to be applied to image formation of an overprint image on a recording medium, the image forming apparatus including:
a conveyer that conveys the recording medium along a conveyance path by a driving roller;
an eye mark detector that is disposed in the conveyance path and detects an eye mark formed on the recording medium in advance;
an image former that is disposed downstream of the eye mark detector in the conveyance path and forms the overprint image at a predetermined position on the recording medium with reference to a position of the eye mark on the recording medium; and
a speed detector that includes a speed detection roller to be brought into contact with the recording medium in the conveyance path and detects a conveyance speed of the recording medium based on a rotation speed of the speed detection roller,
in which
the eye mark detector is disposed at a position separated by an integral multiple of a roller circumferential length of the driving roller and also by a non-integral multiple of a roller circumferential length of the speed detection roller from a position at which the image former forms the overprint image on the recording medium.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates an aspect of overprint printing;

FIG. 2 illustrates an aspect of overprint printing;

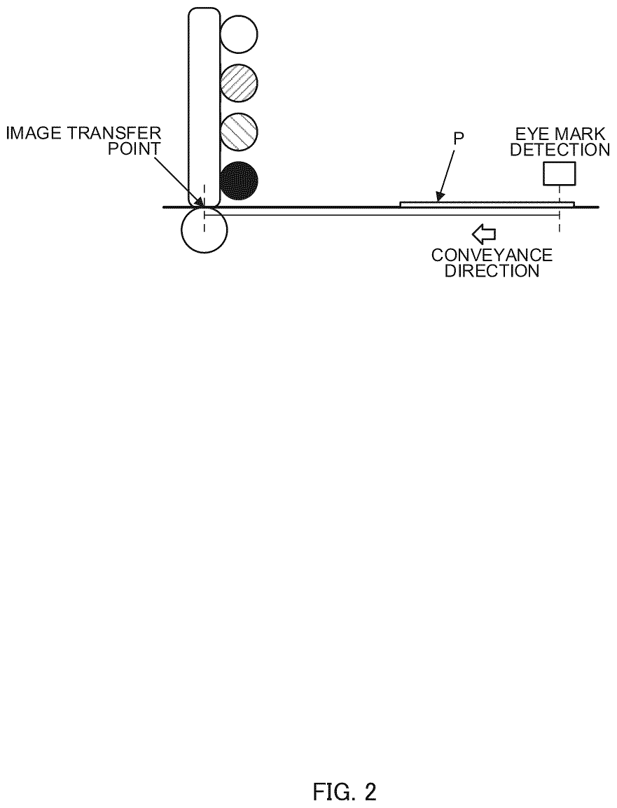

FIG. 3 illustrates an overall configuration of an image forming system according to an embodiment of the present invention;

FIG. 4 illustrates a configuration of a control system of the image forming system according to an embodiment of the present invention;

FIG. 5 illustrates a configuration of a controller of the image forming system according to an embodiment of the present invention;

FIG. 6 illustrates a configuration of a speed detector of the image forming system according to an embodiment of the present invention;

FIG. 7 schematically illustrates an arrangement position of an eye mark detector according to an embodiment of the present invention;

FIG. 8A illustrates the influence of the eccentricity of a driving roller on the position at which the overprint image is formed on a sheet;

FIG. 8B illustrates the influence of the eccentricity of the driving roller on the position at which the overprint image is formed on the sheet;

FIG. 9 illustrates a design concept of a diameter of a roller according to an embodiment of the present invention;

FIG. 10 illustrates an example of a t-ΔV waveform of the sheet conveyance speed observed in a state where the diameter of the driving roller is increasing;

FIG. 11 illustrates an example of a control flow by an image forming timing adjustment function of the controller according to the embodiment of the present invention;

FIG. 12 illustrates an example of a control flow by a conveyance speed correction function of a controller according to an embodiment of the present invention;

FIGS. 13A to FIG. 13C illustrates an example of a speed fluctuation component included in the measurement data of the sheet conveyance speed;

FIG. 14 illustrates an example of a frequency analysis result of measurement data of the sheet conveyance speed;

FIG. 15 illustrates an example of a frequency setting table in which frequencies corresponding to one rotation periods of the driving roller and the roller are defined;

FIG. 16 illustrates an example of a speed fluctuation canceling waveform according to an embodiment of the present invention; and

FIG. 17 illustrates a modification example of a control flow by a conveyance speed correction function of the controller according to an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

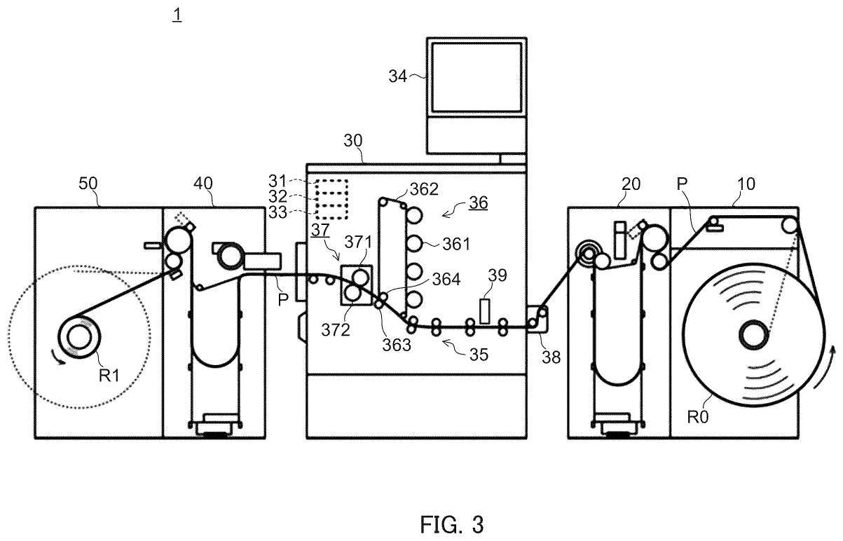

Hereinafter, an example of a configuration of an image forming system (hereinafter, referred to as an image forming system 1) according to an embodiment of the present invention will be described with reference to FIG. 3 to FIG. 6.

In the present embodiment, a continuous sheet (hereinafter, referred to as sheet P) is used as a recording medium on which an overprint image is to be formed in the image forming system 1. Provided that the recording medium is not limited to a paper medium but may be, for example, a cloth or a film.

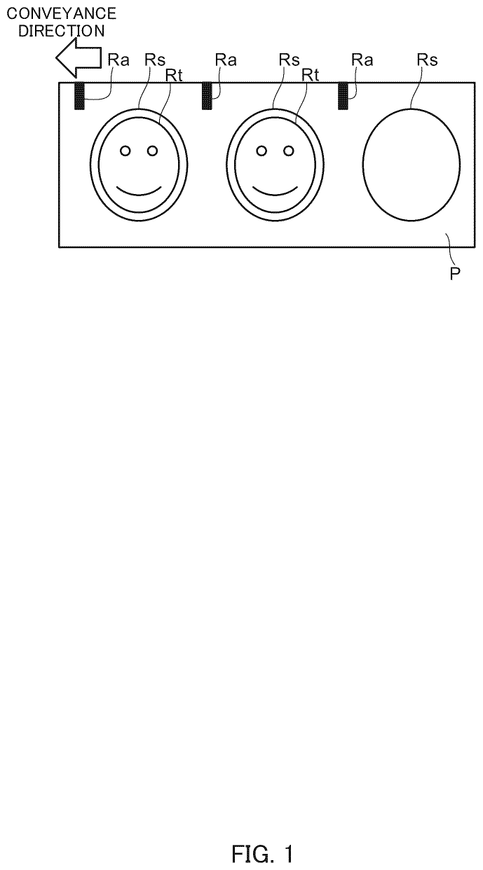

Note that an eye mark is formed on a sheet P at the same time as the base image is formed. As described above, the eye mark is an image indicating the reference position on the sheet P in the conveyance direction. For example, as illustrated in FIG. 1, the eye mark may be an I-shaped mark extending in the width direction of the sheet P, a T-shaped mark, or any other mark. In the present embodiment, the eye mark is formed, for example, as a black I-shaped mark at a dividing position between pages in a non-image forming region on the sheet P (e.g., an end portion of the sheet P in a width direction).

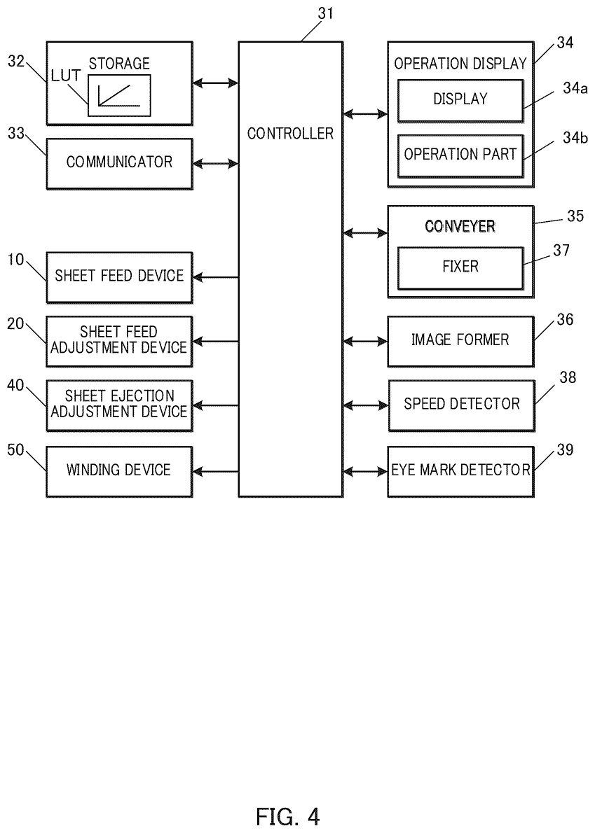

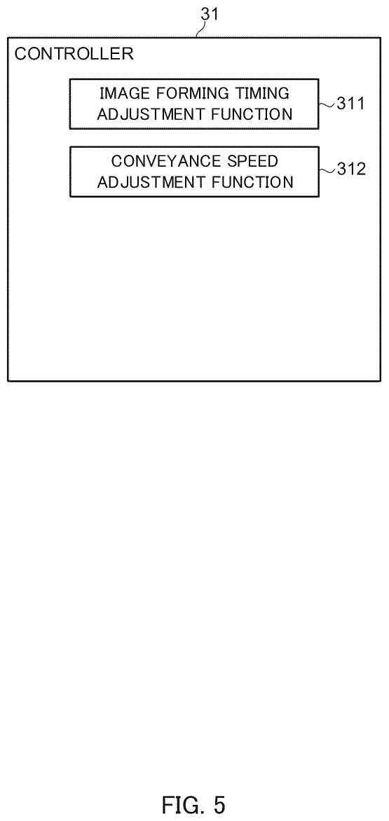

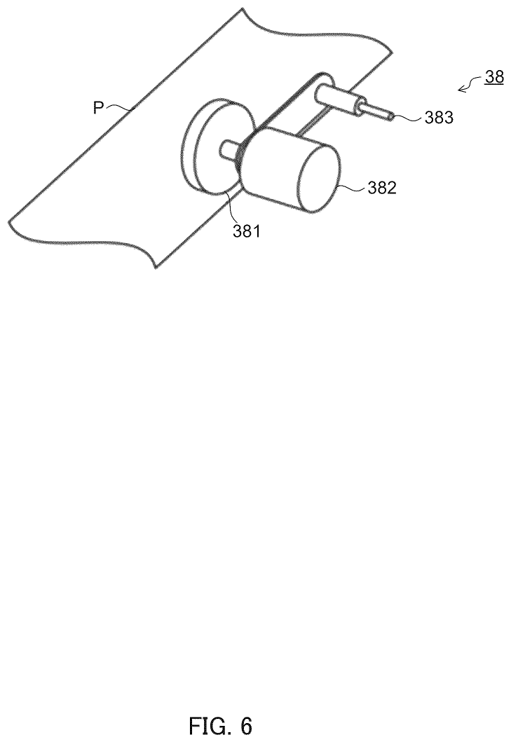

FIG. 3 illustrates an overall configuration of the image forming system 1. FIG. 4 illustrates a configuration of a control system of the image forming system 1. FIG. 5 illustrates a configuration of the controller 31 of the image forming system 1. FIG. 6 illustrates a configuration of a speed detector 38 of the image forming system 1.

The image forming system 1 includes a sheet feed device 10, a sheet feed adjustment device 20, an image forming apparatus 30, a sheet ejection adjustment device 40, and a winding device 50. These devices are connected in order from the upstream side to the downstream side in the conveyance direction of the sheet P.

The sheet feed device 10 accommodates and holds a sheet P wound in a roll shape (that is, a roll sheet R0) and supplies the sheet P.

The sheet feed adjustment device 20 holds the sheet P in a slack state and adjusts the supply of the sheet P to the image forming apparatus 30. That is, the sheet feed adjustment device 20 has a buffer function of absorbing a minute difference in the conveyance speed of the sheet P between the sheet feed device 10 and the image forming apparatus 30, the skew of the sheet P, and the like.

The image forming apparatus 30 forms an image based on image data on a sheet P by using a known image forming process such as an electrophotographic process.

The sheet ejection adjustment device 40 sags and holds the sheet P, and adjusts the supply of the sheet P to the winding device 50. That is, similarly to the sheet feed adjustment device 20, the sheet ejection adjustment device 40 has a buffer function of absorbing a minute difference in the conveyance speed of the sheet P between the image forming apparatus 30 and the winding device 50, the skew of the sheet P, and the like.

The winding device 50 winds the ejected sheet P into a roll to form roll paper R1.

Subsequently, details of the image forming apparatus 30 will be described.

The image forming apparatus 30 includes a controller 31, a storage 32, a communicator 33, an operation display 34, a conveyer 35, an image former 36, a fixer 37, a speed detector 38, and an eye mark detector 39. These constituent elements are connected to each other via a bus for exchanging signals.

The controller 31 includes a CPU, executes control of the above-described components and various kinds of arithmetic processing in accordance with various kinds of programs stored in the storage 32, and integrally controls the image forming system 1.

For example, the controller 31 controls conveyance of the sheet P by controlling the sheet feed device 10, the sheet feed adjustment device 20, the sheet ejection adjustment device 40, and the winding device 50.

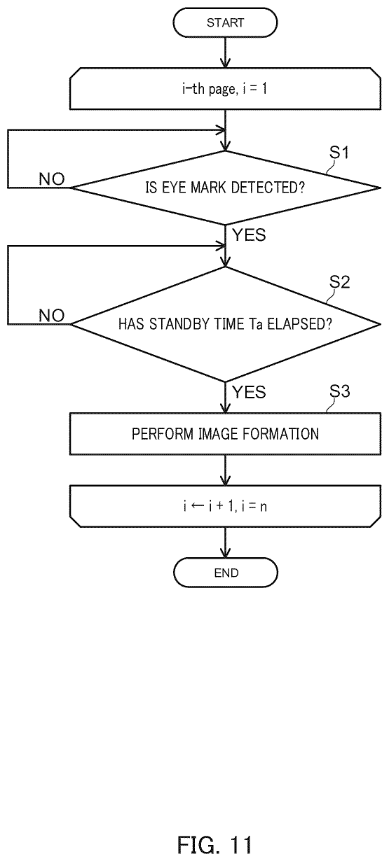

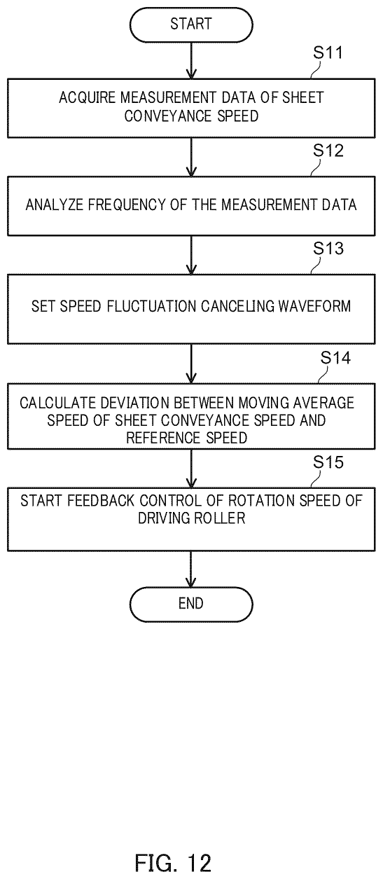

Here, the controller 31 has an image forming timing adjustment function 311 and a conveyance speed adjustment function 312 see FIG. 5). The image forming timing adjustment function 311 is a function of controlling the image former 36 to transfer the overprint image onto the sheet P after a predetermined timing, which is triggered by the timing at which the eye mark on the sheet P is detected by the eye mark detector 39. The conveyance speed adjustment function 312 is a function of performing feedback control of the rotation speed of the driving roller (here, the fixing roller 371) based on the conveyance speed of the sheet P sequentially detected by the speed detector 38. Note that the image forming timing adjustment function 311 will be described later with reference to FIG. 11. In addition, the conveyance speed adjustment function 312 will be described later with reference to FIG. 12 to FIG. 16.

The storage 32 includes a ROM that stores various programs and various data in advance, a RAM that temporarily stores programs and data as a work area, a hard disk that stores various programs and various data, and the like.

The communicator 33 includes an interface for communicating with another device such as a user's PC. The communicator 33 receives, for example, a print job from a user's PC.

The operation display 34 includes, for example, a liquid crystal display with a touch panel, and functions as a display 34a and an operation part 34b. According to a display control signal input from the controller 31, the display 34a displays various operation screens, states of images, individual function operation status, printing-related information, or the like. The operation part 34b includes various operation keys such as a numeric keypad, and a start key, receives various input operation from a user, and outputs an operation signal to the controller 31.

The conveyer 35 includes a plurality of conveying rollers disposed along a conveyance path, and conveys the sheet P along the conveyance path.

The image former 36 forms an image based on the input image data on the sheet P conveyed by the conveyer 35. The image former 36 is, for example, an electrophotographic image former including a photoreceptor 361 of each color, an intermediate transfer belt 362, a transfer roller 363, and an opposing roller 364.

To be specific, the image former 36 records a color image on the sheet P by outputting four colors of yellow (Y), magenta (M), cyan (C), and black (K) on the sheet P with a predetermined number of gradations based on the input image data.

The image formers 36 charges the photoreceptor 361 for each color, and then scans the photoreceptor 361 with a light beam emitted from the optical scanner based on the original image, thereby forming an electrostatic latent image. Then, the image former 36 supplies a color material such as a toner and develops the image, thereby forming an image on the photoreceptor 361. The image former 36 sequentially transfers the images formed on the four photoreceptors 361 onto the intermediate transfer belt 362 in a superimposed manner. Thus, an image of each color is formed on the intermediate transfer belt 362.

The intermediate transfer belt 362 is an endless belt supported by a plurality of rollers so as to be able to travel, and conveys the image transferred by the photoreceptor 361 in the primary transfer region to the secondary transfer region. The transfer roller 363 is disposed in the secondary transfer region and forms a nip portion with an opposing roller 364 that opposes the transfer roller 363 with the intermediate transfer belt 362 interposed therebetween. The transfer roller 363 transfers the image conveyed by the intermediate transfer belt 362 to the sheet P passing through the nip portion.

Note that the image former 36 is disposed downstream of the eye mark detector 39 in the conveyance path. Then, the image former 36 forms the overprint image at a predetermined position on the sheet P with reference to the position of the eye mark on the sheet P under the control of the controller 31.

The fixer 37 includes a fixing roller 371 and a pressure roller 372, and applies heat and pressure to the sheet P on which the image has been formed by the image former 36 to fix the image on the sheet P. The fixing roller 371 is heated by a heater disposed inside, a heating roller (not illustrated) disposed outside, or the like. The pressure roller 372 forms a nip portion between itself and the opposed fixing roller 371, and the sheet P passing through the nip portion is heated and pressurized.

The fixing roller 371 is driven by a driving motor, also functions as a driving roller for conveying the sheet P, and constitutes a part of the conveyer 35. Since the fixing roller 371 needs to heat and press the sheet P, it is usually set to have the strongest conveying force as compared with other motor-driven conveying rollers. For example, the transfer roller 363 also has a sheet conveying force, but the conveying force of the transfer roller 363 is smaller than the conveying force of the fixing roller 371. That is, in the image forming apparatus 30 according to the present embodiment, the rotation speed of the fixing roller 371 substantially determines the conveyance speed of the sheet P. As a driving motor for operating the fixing roller 371, for example, a stepping motor capable of controlling a rotation speed for each rotation position is used.

In the present embodiment, the conveyance speed of the sheet P is controlled by controlling the rotation speed of the fixing roller 371. Hereinafter, the fixing roller 371 is also referred to as a “driving roller 371”.

The speed detector 38 detects the conveyance speed of the sheet P. The speed detector 38 includes, for example, a roller 381 and a rotary encoder 382 connected to the roller 381. The roller 381 is rotatably supported at a fixed point at a position at which it abuts against the sheet P on the conveyance path. Then, the roller 381 is rotated by a friction force received from the sheet P with the conveyance of the sheet P. The rotary encoder 382 is positioned by the fulcrum 383, and outputs a pulse signal each time the rotation of the roller 381 by a predetermined angle is detected. That is, the output signal of the rotary encoder 382 changes based on the rotation speed of the roller 381, and the conveyance speed of the sheet P is sequentially detected.

Note that the speed detector 38 transmits measurement data of the sheet conveyance speed to be sequentially detected to the controller 31. With reference to measurement data of the sequentially detected sheet conveyance speed, the controller 31 performs feedback control of the rotation speed of the driving roller 371 to suppress speed fluctuation of the sheet conveyance speed.

The roller 381 is preferably disposed upstream of the fixer 37 in the conveyance direction of the sheet P so as to be separated from the fixer 37. The atmosphere in the vicinity of the fixer 37 tends to have a high temperature due to the influence of the heater in the fixer 37. When the temperature of the roller 381 is increased, a diameter of the roller 381 is changed by thermal expansion, which adversely affects accuracy in detection of the conveyance speed. From such a viewpoint, in the present embodiment, the roller 381 is disposed outside the main body of the image forming apparatus 30 upstream of the transfer roller 363 in the conveyance direction. However, the roller 381 may be disposed upstream of the transfer roller 363 in the conveyance direction.

The eye mark detector 39 is provided upstream of the image former 36 in the conveyance path, and detects an eye mark formed on the sheet P. As the eye mark detector 39, for example, a reflection-type optical sensor is used which irradiates the upper surface of the sheet P with light and detects eye marks formed on the sheet P from reflected light observed at that time. However, a transmission-type optical sensor or another sensor may be used as the eye mark detector 39.

Each time an eye mark on the sheet P is detected, the eye mark detector 39 transmits the detection result to the controller 31.

### <Arrangement Position of Eye Mark Detector 39>

Here, an arrangement position of the eye mark detector 39 in the image forming apparatus 30 will be described.

As described above, the reason why the conveyance time of a sheet from the detection of the eye mark at the eye mark detection position to the image transfer point varies is due to the speed fluctuation in the sheet conveyance speed. Usually, in the image forming apparatus 30, the rotation speed of the driving roller 371 of the conveyer 35 is controlled so that the conveyance speed of the sheet P becomes constant at a reference speed. However, actually, within the image forming apparatus 30, rotation speed unevenness associated with eccentricity of the driving roller 371, rotation speed fluctuation associated with a change in the diameter of the driving roller 371, and rotation speed unevenness associated with eccentricity of the roller 381, and the like occur, which in turn cause speed fluctuations in the sheet conveyance speed.

Here, the eccentricity of the driving roller 371 is caused by, for example, a processing error at the time of manufacturing the driving roller, a mounting error at the time of assembly, and the like. The eccentricity of the driving roller 371 also occurs when, for example, a foreign substance adheres to the driving roller 371 during use of the image forming apparatus 30. Note that in the present embodiment, the fixing roller 371 functions as the driving roller.

Furthermore, the diameter change of the driving roller 371 is caused, for example, by thermal expansion of the driving roller 371 due to a temperature change of the driving roller 371 during operation of the image forming apparatus 30. In general, in the image forming apparatus 30, the fixing roller 371 often serves as the driving roller, and typically, the driving roller 371 is placed in a high-temperature state while the image forming apparatus 30 is operating. Therefore, while the image forming apparatus 30 is in operation, the driving roller 371 tends to thermally expand and increase its dimension as the temperature increases. When the diameter of the driving roller 371 increases, the sheet conveyance amount per rotation of the driving roller 371 changes, so that the speed fluctuation of the sheet conveyance speed occurs.

Furthermore, the eccentricity of the roller 381 for detecting speed (i.e., speed detection roller) is caused by, for example, processing errors during manufacture or installation errors during assembly, similarly to the driving roller 371. The eccentricity of the roller 381 is also caused by adhesion of a foreign substance to the roller 381 during use of the image forming apparatus 30. The sheet conveyance speed detected by the roller 381 is generally fed back to the controller 31 and used for rotation speed control of the driving roller 371 that conveys the sheet P. For this reason, in a case where the eccentricity occurs in the roller 381, measurement errors of the sheet conveyance speed are induced, and accordingly, operation amount errors at the time of rotation speed control of the driving roller 371 in the controller 31 are caused.

In the image forming apparatus 30 according to the present embodiment, the arrangement position of the eye mark detector 39 is set with the aim of improving the robustness against the speed fluctuation of the sheet conveyance speed.

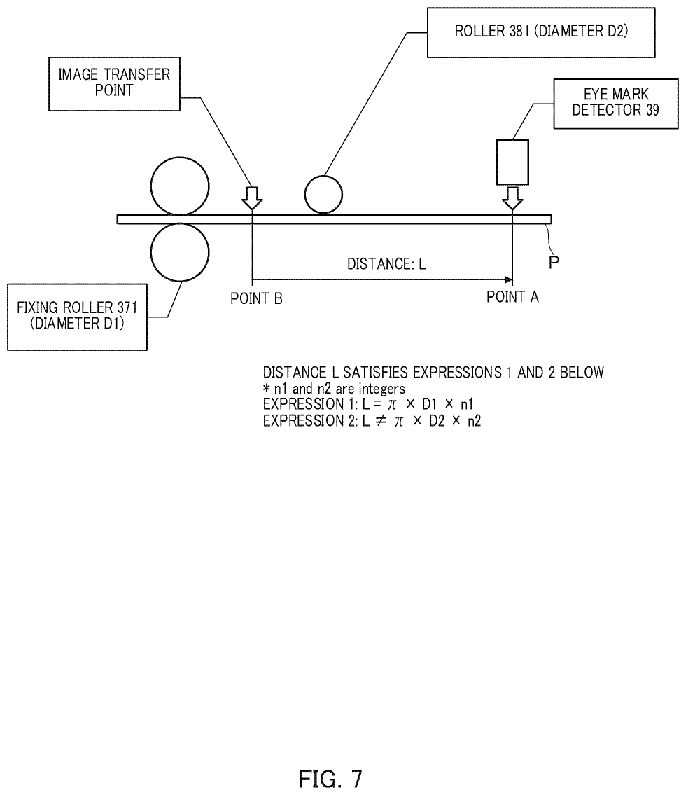

FIG. 7 schematically illustrates the arrangement position of the eye mark detector 39.

The eye mark detector 39 is disposed at a position separated by an integral multiple of the roller circumferential length of the driving roller 371 and also by a non-integral multiple of the roller circumferential length of the roller 381 from the position at which the image former 36 forms the overprint image on the sheet P. That is, the arrangement position of the eye mark detector 39 is set so as to satisfy the following Expression (1) and Expression (2).

L=π×D1×n1 Expression (1)
(L represents a distance from the eye mark detection position to the image transfer point. D1 represents a diameter of the driving roller 371. n1 represents an arbitrary integer)

L≠π×D2×n2 Expression (2)
(L represents a distance from the eye mark detection position to the image transfer point. D2 represents a diameter of the roller 381 and n2 represents an arbitrary integer)

First, the relationship of Expression (1) will be described.

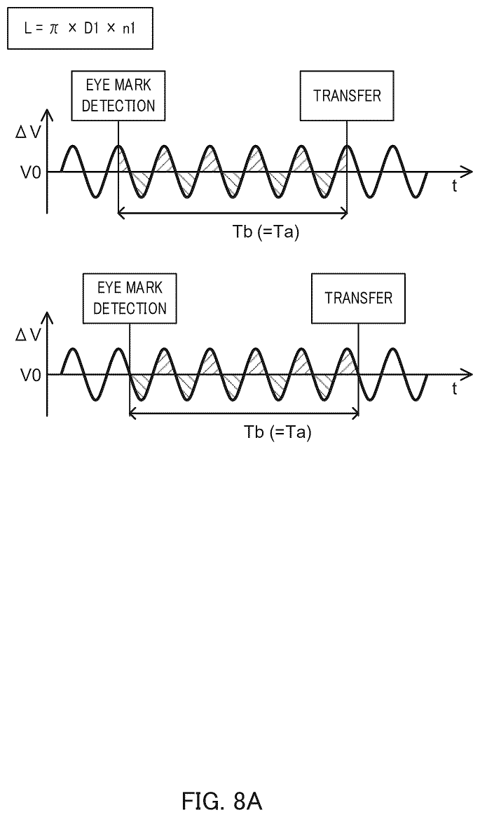

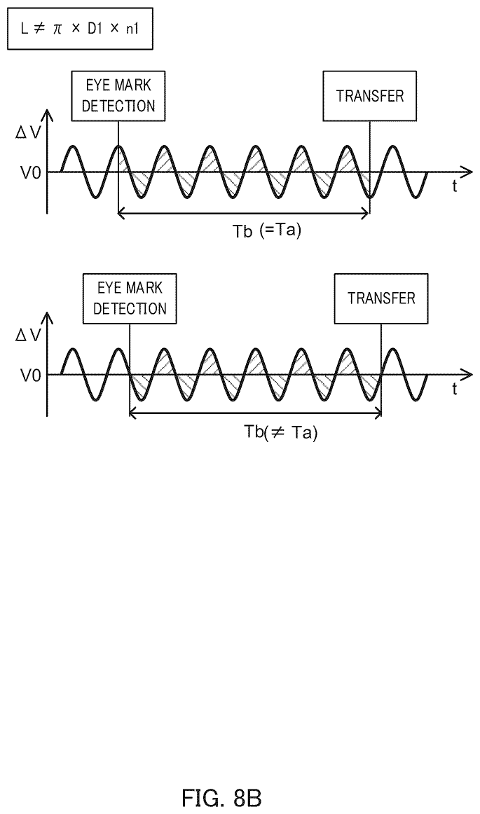

FIGS. 8A and 8B illustrates the influence of the eccentricity of the driving roller 371 on the position at which the overprint image is formed on the sheet P.

FIG. 8A illustrates a t-ΔV waveform in a state where a positional relationship between an eye mark detection position and an image transfer point satisfies the following Expression (1). FIG. 8B illustrates a t-ΔV waveform in a state where the positional relationship between the eye mark detection position and the image transfer point does not satisfy the following Expression (1). The upper and lower diagrams of FIG. 8A illustrate t-ΔV waveforms observed at different timings. The upper and lower diagrams of FIG. 8B illustrate t-ΔV waveforms observed at different timings.

In the t-ΔV waveform, the horizontal axis t represents a time axis, and the vertical axis ΔV represents a speed fluctuation component of the sheet conveyance speed with respect to the reference speed V0 (the same applies hereinafter). From the t-ΔV waveforms in FIG. 8A and FIG. 8B, the behavior of the speed fluctuation of the sheet conveyance speed due to the eccentricity of the driving roller 371 can be read from the detection of the eye mark to the image transfer. Note that Tb in FIGS. 8A and 8B represents a sheet conveyance time from the eye mark detection position (point A) to the image transfer point (point B). Hereinafter, the sheet conveyance time Tb is also referred to as “conveyance time Tb between point A and point B”.

Note that a standby time Ta from the detection of an eye mark to the start of image transfer is set in the controller 31. The standby time Ta is set on the assumption that the sheet P is being conveyed at the reference speed V0. Ideally, the standby time Ta and the conveyance time Tb between point A and point B coincide with each other. Hereinafter, the standby time Ta from the detection of the eye mark set in the controller 31 to the image transfer is also referred to as a “standby time Ta”.

In a case where the eccentricity occurs in the driving roller 371, the sheet conveyance speed does not become constant at the reference speed V0, but changes sinusoidally in a period of one rotation of the driving roller 371. Therefore, with the speed fluctuation ΔV, an actual sheet conveyance time Tb from the eye mark detection position to the image transfer point may be shifted from the standby time Ta calculated when the sheet P is conveyed at the constant reference speed V0. That is, in this case, a positional deviation may occur in the overprint image on the sheet P.

Therefore, in the image forming apparatus 30 according to the present embodiment, the distance from the eye mark detection position to the image transfer point is set to an integral multiple of the roller circumferential length of the driving roller 371, thereby canceling the speed fluctuation ΔV in the sheet conveyance speed caused by the eccentricity of the driving roller 371.

That is, in this case, the number of times the speed fluctuation ΔV included in the conveyance time Tb between the point A and the point B rises and falls with respect to the reference speed V0 is determined by one rotation period of the driving roller 371. Therefore, by setting the positional relationship of the above-described Expression (1), the number of times that the speed fluctuation ΔV included in the conveyance time Tb between point A and point B rises and falls with respect to the reference speed V0 becomes the same even at different timings as illustrated in the upper and lower diagrams of FIG. 8A. FIG. 8A indicates that the conveyance time Tb between the point A and the point B always includes a time period in which the speed is increased with respect to the reference speed V0 for five mountains and includes a time period in which the speed is decreased with respect to the reference speed V0 for five mountains.

Therefore, in the state where the above Expression (1) is satisfied, the sheet conveyance time Tb from the eye mark detection position to the image transfer point is substantially the same as that in the case where the eccentricity of the driving roller 371 does not occur even when the eccentricity of the driving roller 371 occurs. In other words, even when the eccentricity of the driving roller 371 occurs, the actual sheet conveyance time Tb from the eye mark detection position to the image transfer point is substantially the same as the standby time Ta preset in the controller 31. Therefore, the positional deviation of the image formation position on the sheet P does not occur.

On the other hand, in a state in which Expression (1) is not satisfied, when the eye mark detection timing is different, the number of times that the speed fluctuation ΔV included in the conveyance time Tb between point A and point B rises and falls with respect to the reference speed V0 is different. In the upper part of FIG. 8B, the conveyance time Tb between point A and point B includes a time period in which the speed increases relative to the reference speed V0 for 5.5 mountains and a time period in which the speed decreases relative to the reference speed V0 for 5.5 mountains. On the other hand, in the lower diagram, the conveyance time Tb between point A and point B includes a time period in which the speed increases relative to the reference speed V0 for five mountains and a time period in which the speed decreases relative to the reference speed V0 for six mountains.

Therefore, in a case where the eccentricity occurs in the driving roller 371 in a state where Expression (1) is not satisfied, the conveyance time Tb between point A and point B changes according to the eye mark detection timing. In other words, in a case where the eccentricity occurs in the driving roller 371, the actual sheet conveyance time from the eye mark detection position to the image transfer point deviates from the standby time Ta set in advance in the controller 31 at each time. Therefore, a positional deviation of the image forming position on the sheet P occurs.

In this way, in the image forming apparatus 30 according to the present embodiment, by setting the arrangement position of the eye mark detector 39 so as to satisfy Expression (1), the robustness against the positional deviation of the image formation with respect to the eccentricity of the driving roller 371 is improved.

Next, the relationship of Expression (2) will be described.

In the image forming apparatus 30 according to the present embodiment, the diameter of the roller 381 is designed based on the relationship with the diameter of the driving roller 371.

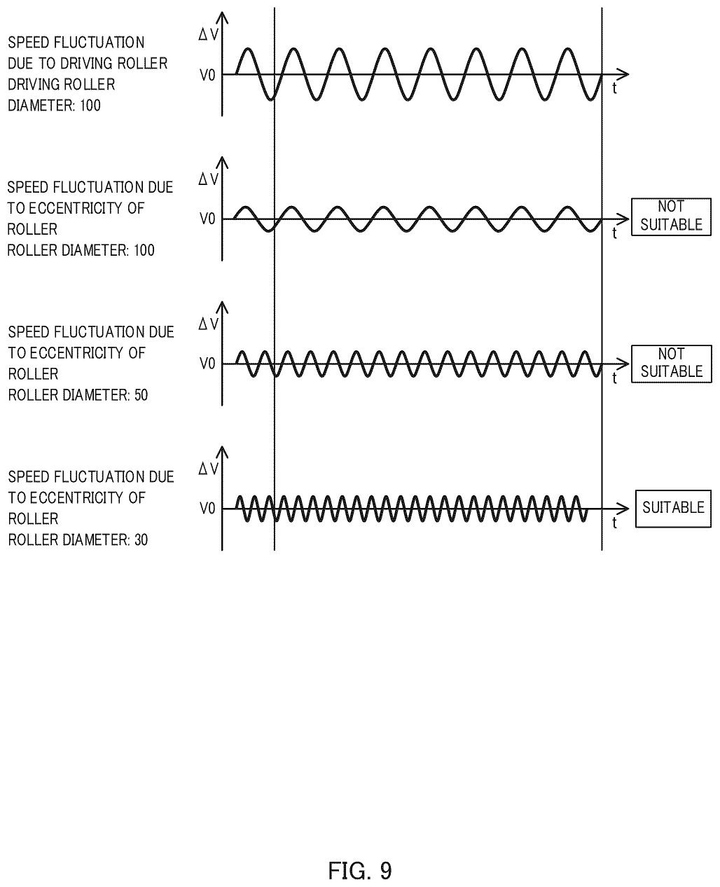

FIG. 9 illustrates a design concept of a diameter of a roller 381. The top of FIG. 9 illustrates, as a t-ΔV waveform, a variation in the sheet conveyance speed due to the eccentricity of the driving roller 371 in a case where the diameter of the driving roller 371 is defined as 100. Furthermore, the lower parts of FIG. 9 illustrate, as t-ΔV waveforms, fluctuations in the sheet conveyance speed due to the eccentricity of the roller 381 in a case where the diameter of the roller 381 is set as a 100/50/30.

In the above description, only the eccentricity of the driving roller 371 is used as the speed fluctuation factor of the sheet conveyance speed, and the countermeasure thereof is described. However, according to findings of the inventor of the present application, actually, the sheet conveyance speed is also significantly influenced by a change in the diameter of the driving roller 371 and the eccentricity of the roller 381 for detecting speed.

To cope with these, first, it is necessary to separate the speed fluctuation component due to the driving roller 371 and the speed fluctuation component due to the roller 381 included in the measurement data of the sheet conveyance speed obtained by the speed detector 38.

Note that in a case where the eccentricity occurs in the roller 381, a measurement error of the sheet conveyance speed is induced, and along with this, for example, an operation amount error is caused when the rotation speed of the driving roller 371 is feedback-controlled. Therefore, for example, as illustrated in FIG. 9, the actual sheet conveyance speed does not become constant at the reference speed V0 but changes sinusoidally in a period of one rotation of the roller 381.

From such a viewpoint, the controller 31 according to the present embodiment performs frequency analysis on the measurement data of the sheet conveyance speed obtained by the speed detector 38 to separate the speed fluctuation component caused by the driving roller 371 and the speed fluctuation component caused by the roller 381 included in the measurement data. When controlling the sheet conveyance speed, a method for selectively reducing the speed fluctuation component caused by the driving roller 371 is adopted. When the diameter of the driving roller 371 is changed, the relationship of Expression (1) is not satisfied, and thus it is necessary to reduce the speed fluctuation component caused by the driving roller 371.

Therefore, in the image forming apparatus 30 according to the present exemplary embodiment, the diameter of the driving roller 371 is set to be a non-integral multiple of the diameter of the driven roller 381 as represented by the following Expression (3).

D1≠D2×n3 Expression (3)
(D1 represents the diameter of driving roller 371, D2 represents a diameter of the roller 381, and n3 represents an arbitrary integer)

FIG. 9 schematically illustrates this point.

In the present embodiment, the diameter of the roller 381 of the speed detector 38 is designed to be smaller than the diameter of the driving roller 371. This is because, in general, the effect of the eccentricity of the roller 381 on the accuracy of measurement of the sheet conveyance speed is smaller and an accuracy error as a component is also smaller in a roller 381 having a small diameter than in a roller 381 having a large diameter. Therefore, it is preferable to use a roller 381 having a small diameter in order to measure the conveyance speed of the sheet P with high accuracy.

When the diameter of the driving roller 371 is equal to the diameter of the roller 381 or is in a relation of an integral multiple of the diameter of the roller 381 (in FIG. 9, the diameter of the roller 381 is 100 or 50), the speed fluctuation of the sheet conveyance speed has a synchronized behavior in the period of the driving roller 371 and the period of the roller 381. In this case, at the time of frequency analysis, a speed fluctuation component caused by the roller 381 is superimposed on a speed fluctuation component caused by the driving roller 371, and thus it is difficult to separate the two components.

In this regard, by designing the diameter of the driving roller 371 and/or the diameter of the roller 381 as in the above Expression (3), it is possible to execute the frequency analysis of the measurement data of the sheet conveyance speed in a short time and with high accuracy. In FIG. 9, for the above-described reason, in relation to the diameter of the driving roller 371, the case where the diameter of the roller 381 is 100 or 50 is not suitable, and only the case where the diameter of the roller 381 is 30 is suitable.

When the relationship of Expression (3) is substituted into Expression (1), the relationship of Expression (2) is derived. That is, it is found that the eye mark detector 39 is required to be disposed at a position separated from the position at which the overprint image is formed on the sheet P by a non-integral multiple of the roller circumferential length of the roller 381.

L=π×D1×n1 Expression (1)

D1≠D2×n3 Expression (3)

L≠π×D2×n2 Expression (2)

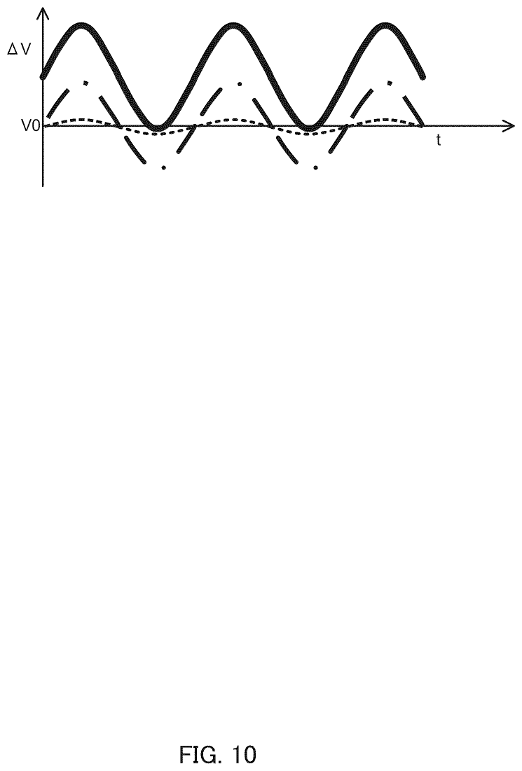

FIG. 10 illustrates an example of a t-ΔV waveform of the sheet conveyance speed observed in a state where the diameter of the driving roller 371 is increasing. Note that lines in FIG. 10 indicate the following.
Dotted line: sheet conveyance speed in normal state
Solid line: sheet conveyance speed when diameter of driving roller 371 is increasing
One dot chain line: sheet conveyance speed when eccentricity of the driving roller 371 occurs

When the diameter of the driving roller 371 is changed, the actual sheet conveyance speed behaves differently from the case where the driving roller 371 is eccentric. When the driving roller 371 is eccentric, as described above, the sheet conveyance speed does not become constant at the reference speed V0 but changes sinusoidally in a period of one rotation of the driving roller 371 (one dot chain line).

On the other hand, when the diameters of the driving rollers 371 are increasing, the sheet conveyance speed has a higher average speed than the the reference speed V0 and a larger amplitude of the speed fluctuation than the reference speed V0 (solid line). Therefore, even when the distance from the eye mark detection position to the image transfer point is set to satisfy the relation of the Expression (1) based on the time of non-expansion of the driving roller 371, the speed fluctuation ΔV of the sheet conveyance speed cannot be canceled.

From this point of view, the controller 31 according to the present embodiment employs a method of performing frequency analysis of the measurement data of the sheet conveyance speed, detecting the speed fluctuation ΔV of the sheet conveyance speed due to the change in diameter of the driving roller 371 and selectively reducing the speed fluctuation ΔV. This will be described later with reference to FIG. 12.

### <Image Forming Timing Adjustment Function of Controller 31>

Next, the image forming timing adjustment function 311 of the controller 31 will be described.

The image forming timing adjustment function 311 controls the image former 36 to transfer the overprint image onto the sheet P after the predetermined standby time Ta, triggered by the timing at which the eye mark on the sheet P is detected by the eye mark detector 39.

FIG. 11 illustrates an example of a control flow by the image forming timing adjustment function 311 of the controller 31.

In this embodiment, for example, as illustrated in FIG. 1, the eye mark is formed as a black I-shaped mark at a dividing position of each page in a non-image forming region on the sheet P. The controller 31 forms an image (overprint image) of each page at a predetermined position on the sheet P with reference to the position of the eye mark provided on each page on the sheet P. The processing of step S1 to step S3 represents loop processing for the i-th (where i is a variable) page.

In step S1, the controller 31 determines whether or not an eye mark has been detected on the sheet P by the eye mark detector 39. Then, when the eye mark on the sheet P is detected (S1: YES), the controller 31 advances the processing to step S2. On the other hand, when the eye mark on the sheet P is not detected (S1: NO), the controller 31 waits until the eye mark on the sheet P is detected.

In step S2, the controller 31 determines whether or not the standby time Ta from the detection of the eye mark on the sheet P to the arrival at the image transfer point has elapsed. Next, when the standby time Ta has elapsed (S2: YES), the controller 31 proceeds to step S3. On the other hand, when the standby time Ta has not elapsed (S2: NO), the controller 31 waits for the standby time Ta until the image transfer point is reached to elapse. Note that the standby time Ta is a sheet conveyance time set on the assumption that the sheet P is conveyed from the eye mark detection position to the image transfer point at the reference speed V0.

In step S3, the controller 31 controls the image former 36 to perform image formation at a predetermined position on the sheet P. Then, the controller 31 increments the variable i of the i-th page by one page, returns to the processing in step S1, and executes the image forming process of the next page.

The controller 31 performs image formation on all the pages of the sheet P by sequentially executing such image formation processing from the first page to the final page (n-th page) of the sheet P.

### <Conveyance Speed Correction Function of Controller 31>

Next, the conveyance speed adjustment function 312 of the controller 31 will be described.

The conveyance speed adjustment function 312 is a function of performing feedback control of the rotation speed of the driving roller 371 based on the sheet conveyance speed sequentially detected by the speed detector 38.

As described above, when the diameter of the driving roller 371 is increased, the driving roller 371 behaves differently from when eccentricity occurs in the driving roller 371. Furthermore, the measurement data of the sheet conveyance speed includes a speed fluctuation component associated with the eccentricity of the roller 381.

From this point of view, the controller 31 performs frequency analysis of the measurement data of the sheet conveyance speed. Then, the controller 31 detects the speed fluctuation component of the sheet conveyance speed accompanied by the change in the diameter of the driving roller 371, and feedback controls the rotation speed of the driving roller 371 so as to selectively cancel the speed fluctuation component.

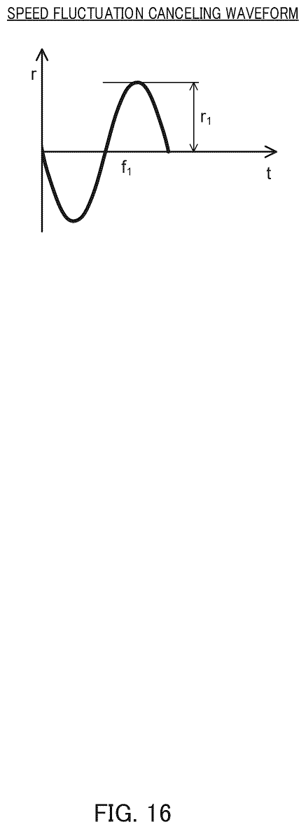

More specifically, for example, the controller 31 sets a speed fluctuation canceling waveform (FIG. 16) so as to selectively cancel the speed fluctuation component of the conveyance speed changing sinusoidally in one rotation period of the driving roller 371. Then, the controller 31 adjusts the reference phase of the speed fluctuation canceling waveform with respect to the sequentially detected sheet conveyance speed, and feedback controls the rotation speed of the driving roller 371. Thus, the speed fluctuation component of the sheet conveyance speed generated with the increase in the diameter of the driving roller 371 is cancelled.

Further, at this time, the controller 31 calculates, for example, a moving average speed per unit time (for example, 1 sec) equal to or more than the rotation period of the driving roller 371 of the sequentially detected sheet conveyance speed. Then, the controller 31 feedback controls the rotation speed of the driving roller 371 such that the moving average speed approaches the reference speed. Thus, the increase in the average speed of the sheet conveyance speed, which has occurred due to the increase in the diameter of the driving roller 371, is cancelled.

FIG. 12 illustrates an example of a control flow by the conveyance speed adjustment function 312 of the controller 31.

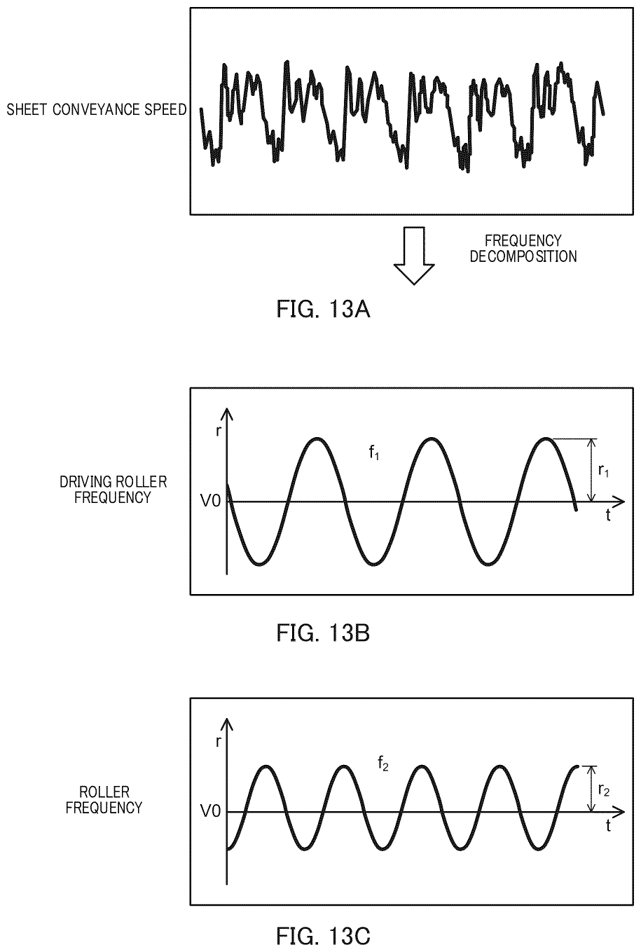

FIGS. 13A to 13C illustrate an example of speed fluctuation components included in data on measurement of the sheet conveyance speed. FIG. 13A illustrates raw data of measurement data of a sheet conveyance speed. FIG. 13B illustrates an example of a speed fluctuation component observed at a frequency corresponding to one rotation period of the driving roller 371 included in the measurement data of the sheet conveyance speed. FIG. 13C illustrates an example of a speed fluctuation component observed at a frequency corresponding to one rotation period of the roller 381 included in the measurement data of the sheet conveyance speed.

Note that hereinafter, the frequency corresponding to one rotation period of the driving roller 371 (i.e., the reciprocal of the rotation period) is referred to as the “rotation frequency of the driving roller 371”. A frequency corresponding to one rotation period of the roller 381 (i.e., the reciprocal of the rotation period) is referred to as a “rotation frequency of the roller 381”.

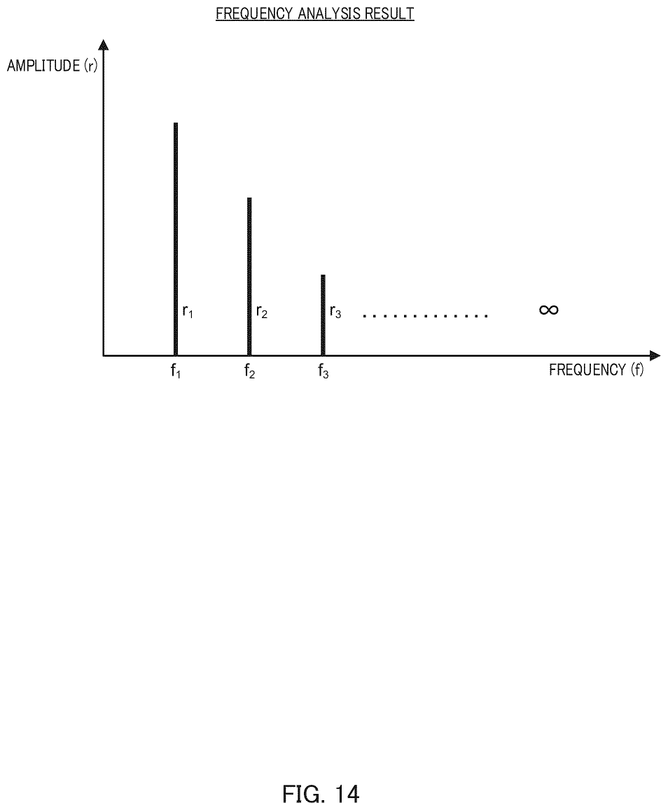

FIG. 14 illustrates an example of a frequency analysis result of measurement data of a sheet conveyance speed.

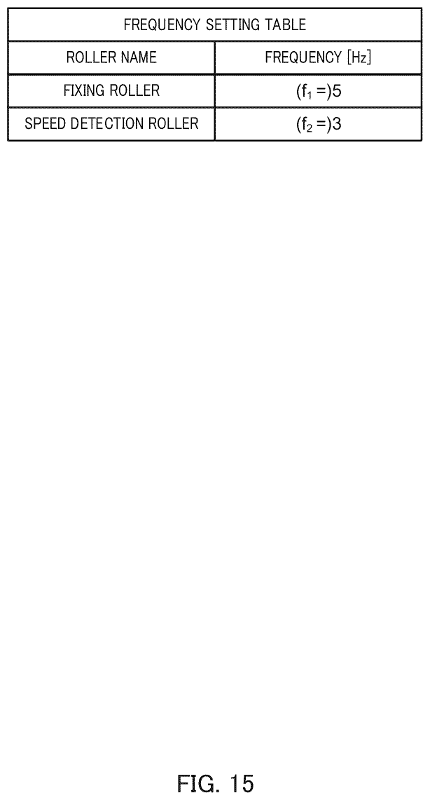

FIG. 15 illustrates an example of a frequency setting table that defines the rotation frequencies of the driving roller 371 and the driven roller 381.

The data of the frequency setting table is calculated in advance based on, for example, the diameter of the driving roller 371 and the diameter of the roller 381, and is stored in the storage 32. Note that the rotation frequency of the driving roller 371 is calculated by, for example, the following Expression (4). The rotation frequency of the roller 381 is calculated by, for example, the following Expression (5).

V0/(π×D1)=f1 Expression (4)
(V0 represents a reference speed of the sheet conveyance speed. D1 represents a diameter of the driving roller 371, and f1 represents a rotation frequency of the driving roller 371)

V0/(π×D2)=f2 Expression (5)
(V0 represents a reference speed of the sheet conveyance speed, D2 represents a diameter of the roller 381, and f2 represents a rotation frequency of the roller 381)

FIG. 16 illustrates an example of a speed fluctuation canceling waveform.

The speed fluctuation canceling waveform is, for example, a sinusoidal waveform that defines a speed change value that periodically changes at the rotation frequency of the driving roller 371. In this speed fluctuation canceling waveform, the amplitude r1 of the speed fluctuation component of the rotational frequency f1 of the driving roller 371 calculated by the frequency analysis is set.

The reference waveform data for setting the speed fluctuation canceling waveform is stored in the storage 32 in advance. The waveform shape of the speed fluctuation canceling waveform is not limited to the sine wave, and a triangular wave or the like may be used.

Each processing of the control flow of FIG. 12 will be described. The flowchart illustrated in FIG. 12 is, for example, processing that the controller 31 repeatedly executes at predetermined intervals (e.g., every 100 msec) according to a computer program.

In step S11, the controller 31 acquires the measurement data of the sheet conveyance speed obtained by the speed detector 38. Note that the time series data of the sheet conveyance speed sequentially detected is output as the measurement data from the speed detector 38.

In step S11, the controller 31 acquires the measurement data of the sheet conveyance speed for a predetermined time ago (e.g., for 1 sec) from the present time. As illustrated in FIGS. 13A to 13C, the measurement data of the sheet conveyance speed includes rotation speed fluctuation components of the driving roller 371, rotation speed fluctuation components of the roller 381, and the like.

In step S12, the controller 31 performs frequency analysis (e.g., FFT analysis) of the measurement data.

In step S12, as illustrated in FIG. 14, values of signal intensity (i.e., amplitudes) of respective frequency components are calculated as respective speed fluctuation components included in data on the measurement of the sheet conveyance speed. That is, as a result, the speed fluctuation component at the rotational frequency of the driving roller 371 and the speed fluctuation component at the rotational frequency of the driven roller 381 are separated.

In step S13, the controller 31 sets a speed fluctuation canceling waveform, based on the frequency analysis in step S12.

In step S13, the controller 31 first specifies the speed fluctuation component in the rotation frequency of the driving roller 371 from the frequency analysis result of the measurement data of the sheet conveyance speed based on the frequency setting table illustrated in FIG. 15. For example, as illustrated in FIG. 16, the controller 31 sets the sinusoidal waveform of the frequency f1 corresponding to one rotation period of the driving roller 371 defined in advance as the speed fluctuation canceling waveform. At this time, the controller 31 sets the amplitude r1 at the rotation frequency of the driving roller 371 calculated by the frequency analysis as the amplitude of the speed fluctuation canceling waveform. Here, as the center value of the speed fluctuation canceling waveform, the moving average speed of the sheet conveyance speed calculated in step S14 is set.

In step S14, the controller 31 calculates a moving average speed V1 of the sheet conveyance speed, which is set with a unit time equal to or greater than the rotation period of the driving roller 371, from the measurement data of the measurement data of the sheet conveyance speed. Then, the controller 31 calculates a deviation between the moving average speed V1 and the reference speed V0.

This step S14 is intended to calculate an increase of the moving average speed V1 of the sheet conveyance speed with respect to the reference speed V0, which has occurred with an increase in the diameter of the driving roller 371. Therefore, it is preferable that the moving average speed V1 of the sheet conveyance speed is a moving average speed over a relatively long time that is equal to or longer than one rotation period of the driving roller 371. Furthermore, the time length is more preferably an integral multiple of one rotation period of the driving roller 371. In this step S14, the controller 31 calculates, for example, the moving average speed V1 of the measurement data of the sheet conveyance speed for the most recent 1 second.

Note that based on a deviation between the moving average speed V1 of the sheet conveyance speed and the reference speed V0, an average target value of the rotation speed of the driving roller 371 for bringing an actual value of the moving average speed V1 of the sheet conveyance speed close to the reference speed V0 is calculated.

In step S15, the controller 31 executes feedback control of the rotation speed of the driving roller 371 based on the speed fluctuation canceling waveform and the deviation between the moving average speed V1 of the sheet conveyance speed and the reference speed V0. The control method itself of the feedback control is the same as that of conventionally known feedback control.

In this step S15, for example, the controller 31 first calculates the average target value of the rotation speed of the driving roller 371 from the deviation between the moving average speed V1 of the sheet conveyance speed and the reference speed V0.

Next, the controller 31 calculates a deviation between the speed change value of the speed fluctuation canceling waveform and the current detection value of the sequentially acquired sheet conveyance speed, and calculates an integral value of the deviation in one rotation period of the driving roller 371. Next, the controller 31 sets the reference phase of the speed fluctuation canceling waveform based on the integral value. Here, the timing at which the integral value of the deviation in one rotation period of the driving roller 371 becomes the minimum is the timing at which the speed fluctuation canceling waveform and the waveform of the speed fluctuation component accompanying the diameter change of the driving roller 371 overlap. Therefore, by setting the value of the phase opposite to the timing at which the integral value of the deviation in one rotation period of the driving roller 371 becomes minimum as the reference phase of the speed fluctuation canceling waveform, the speed fluctuation canceling waveform acts to cancel the speed fluctuation component accompanying the diameter change of the driving roller 371.

That is, the controller 31 superimposes, on the average target value of the rotation speed of the driving roller 371, the variation component corresponding to the rotation position of the driving roller 371 calculated from the speed fluctuation canceling waveform, and sets the resultant value as the target value of the rotation speed corresponding to the rotation position of the driving roller 371. Then, the controller 31 operates the driving motor for driving the driving roller 371 in accordance with the target value. Thus, it is possible to selectively cancel the speed fluctuation component of the sheet conveyance speed associated with the change in the diameter of the driving roller 371. That is, as a result, the driving roller 371 can be operated so that the sheet conveyance speed matches the reference speed V0.

Note that the controller 31 executes such feedback control at all times during the printing operation, based on the current detection value of the sheet conveyance speed sequentially acquired by the speed detector 38. Then, the speed fluctuation component of the sheet conveyance speed generated with the increase in the diameter of the driving roller 371 is canceled.

The controller 31 periodically performs the operation of the flowchart of FIG. 12, and calculates the deviation between the moving average speed V1 of the sheet conveyance speed calculated in step S13 and the reference speed V0, or the speed fluctuation canceling waveform to be set in step S14. Next, when the deviation between the moving average speed V1 of the sheet conveyance speed and the reference speed V0 or the change to the speed fluctuation canceling waveform occurs, the controller 31 updates these values and continues the same feedback control.

### Effect

As described above, according to the image forming apparatus 30 of the present embodiment, it is possible to suppress the deviation of the conveyance time until the sheet P is conveyed from the eye mark detection position to the image transfer point. Accordingly, it is possible to suppress a situation in which the formation position of the overprint image is shifted from the base image.

In particular, in the image forming apparatus 30 according to the present embodiment, frequency analysis is performed on the conveyance speed of the sheet P that is sequentially detected. Then, based on the analysis result of the frequency analysis, a speed fluctuation canceling waveform is set so as to selectively cancel the speed fluctuation component of the conveyance speed changing sinusoidally in one rotation period of the driving roller 371. Then, the rotation speed of the driving roller 371 is feedback-controlled in accordance with the speed fluctuation canceling waveform.

As a result, it is possible to separate the speed fluctuation component of the sheet conveyance speed due to the eccentricity of the roller 381 and the speed fluctuation component of the sheet conveyance speed due to the change in the diameter of the driving roller 371. In other words, the rotation speed of the driving roller 371 can be feedback-controlled with high accuracy so that the conveyance time from the eye mark detection position to the image transfer point is kept constant.

### Modification Example

In the above-described embodiment, the controller 31 (conveyance speed correction function) performs feedback control on the rotation speed of the driving roller 371 by focusing on only the rotation frequency component of the driving roller 371 among the speed fluctuation components of the sheet conveyance speed.

In this regard, a main factor of the speed fluctuation component of the sheet conveyance speed may change with time. For example, there is a case where a foreign substance adheres to the roller 381 for speed detection, rotation speed unevenness increases due to the eccentricity of the roller 381, and as a result, speed fluctuation of the sheet conveyance speed increases. Furthermore, the speed fluctuation of the sheet conveyance speed may increase due to factors other than these (e.g., adhesion of a foreign substance to the transfer roller).

From such a viewpoint, the controller 31 may switch the control mode of controlling the rotation speed of the driving roller 371, based on the analysis result of the frequency analysis of the measurement data of the sheet conveyance speed.

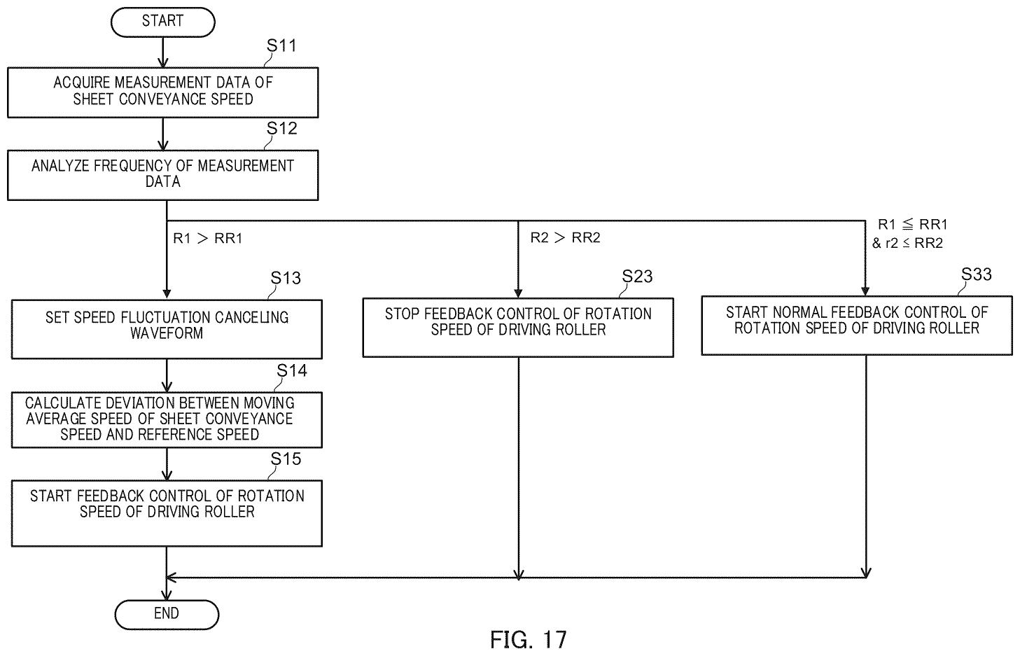

FIG. 17 illustrates a modification example of the control flow by the conveyance speed correction function of the controller 31.

The flowchart of FIG. 17 is different from the flowchart of FIG. 12 in that the control mode for feedback-controlling the rotation speed of the driving roller 371 is switched based on the analysis result of the frequency analysis obtained in the processing of the S12.

To be more specific, when the result of the frequency analysis indicates that the amplitude r1 of the rotation frequency component (f1) of the driving roller 371 in the measurement data of the sheet conveyance speed is larger than a threshold RR1, the controller 31 performs the processing from S13 to S15 as in the above embodiment.

On the other hand, when the analysis result of the frequency analysis indicates that the amplitude f2 of the rotation frequency component (r2) of the rollers 381 in the measurement data of the sheet conveyance speed is larger than a threshold RR2, the controller 31 performs the processing of step S23.

Here, step S23 means that the feedback control of the rotation speed of the driving roller 371 is stopped. That is, the controller 31 controls the rotation speed of the driving roller 371 so as to be the reference speed without depending on the detection value of the sheet conveyance speed obtained from the roller 381.

Note that the reason why the feedback control of the rotation speed of the driving roller 371 is stopped in this step S23 is that it is highly likely that the feedback control of the rotation speed of the driving roller 371 becomes difficult under a situation where the eccentricity of the roller 381 is increasing.

On the other hand, when the analysis result of the frequency analysis indicates that the amplitude f1 of the rotation frequency component (r1) of the driving roller 371 is equal to or less than the threshold RR1 and the amplitude f2 of the rotation frequency component (r2) of the driven roller 381 is equal to or less than the threshold RR2, the controller 31 performs the processing of step S33.

Here, step S33 means switching to a mode in which the rotation speed of the driving roller 371 is controlled by normal feedback control. The normal feedback control means a mode in which the rotation speed of the driving roller 371 is controlled such that a detection value of the sheet conveyance speed sequentially detected approaches a reference speed and a deviation between the detection value of the sheet conveyance speed and the reference speed becomes zero.

Note that this is because in this step S33, it is often possible to further smooth the speed fluctuation of the sheet conveyance speed by performing the normal feedback control under the situation in which the eccentricity of the driving roller 371 or the eccentricity of the roller 381 has not become large.

Then, the controller 31 periodically performs the operation of the flowchart of FIG. 17, and switches the control mode of the feedback control of the rotation speed of the driving roller 371 based on the analysis result of the frequency analysis obtained by the processing of the S12.

As described above, according to the image forming apparatus 30 of the present modification, by switching the control mode for controlling the rotation speed of the driving roller 371 in accordance with the situation in the apparatus, it is possible to further smooth the speed fluctuation of the sheet conveyance speed. That is, as a result, it is possible to suppress the deviation in the conveyance time of sheet P from the eye mark detection position to the image transfer point.

### Other Embodiments

The image forming apparatus according to the present invention has been described with reference to the illustrated embodiment, but the present invention is not limited thereto. For example, the present invention is applicable to overprint printing in an inkjet image forming apparatus.

Although embodiments of the present invention have been described and illustrated in detail, the disclosed embodiments are made for purpose of illustration and example only and not limitation. The scope of the present invention should be interpreted by terms of the appended claims.

### INDUSTRIAL APPLICABILITY

According to the image forming apparatus of the present invention, it is possible to suppress occurrence of a positional deviation between an overprint image and a base image to be formed on a sheet in overprint printing.

### REFERENCE SIGNS LIST

1 Image forming system
10 Sheet feed device
20 Sheet feed adjustment device
30 Image forming apparatus
31 Controller
32 Storage
33 Communicator
34 Operation display
35 Conveyer
36 Image former
37 Fixer
38 Speed detector
39 Eye mark detector
40 Sheet ejection adjustment device
50 Sheet ejection device
311 Image forming timing adjustment function
312 Conveyance speed adjustment function
361 Photoreceptor
362 Intermediate transfer belt
363 Transfer roller
364 Opposing roller
371 Fixing roller (driving roller)
372 Pressure roller
381 Roller
382 Rotary encoder
P Sheet

What is claimed is:

1. An image forming apparatus to be applied to image formation of an overprint image on a recording medium, the image forming apparatus comprising:
a conveyer that conveys the recording medium along a conveyance path by a driving roller;
an eye mark detector that is disposed in the conveyance path and detects an eye mark formed on the recording medium in advance;
an image former that is disposed downstream of the eye mark detector in the conveyance path and forms the overprint image at a predetermined position on the recording medium with reference to a position of the eye mark on the recording medium; and
a speed detector that includes a speed detection roller to be brought into contact with the recording medium in the conveyance path and detects a conveyance speed of the recording medium based on a rotation speed of the speed detection roller,
wherein
the eye mark detector is disposed at a position separated by an integral multiple of a roller circumferential length of the driving roller and also by a non-integral multiple of a roller circumferential length of the speed detection roller from a position at which the image former forms the overprint image on the recording medium.

2. The image forming apparatus according to claim 1, further comprising:
a hardware processor that performs frequency analysis on the conveyance speed of the recording medium, and controls a rotation speed of the driving roller based on an analysis result of the frequency analysis, the conveyance speed being sequentially detected.

3. The image forming apparatus according to claim 2, wherein
the hardware processor sets, based on the analysis result of the frequency analysis, a speed fluctuation canceling waveform so as to selectively cancel a speed fluctuation component of the conveyance speed that changes in a rotation period of the driving roller, and feedback controls the rotation speed of the driving roller in accordance with the speed fluctuation canceling waveform.

4. The image forming apparatus according to claim 3, wherein
the speed fluctuation canceling waveform is a sinusoidal waveform having a frequency corresponding to the rotation period of the driving roller and having an amplitude of the speed fluctuation component of the conveyance speed changing in the rotation period of the driving roller, the amplitude being calculated by the frequency analysis.

5. The image forming apparatus according to claim 3, wherein
the hardware processor further calculates a moving average speed of the conveyance speed of the recording medium sequentially detected, and feedback controls the rotation speed of the driving roller such that the moving average speed approaches a reference speed, the moving average speed being a moving average speed per unit time that is equal to or more than the rotation period of the driving roller.

6. The image forming apparatus according to claim 2, wherein
the hardware processor changes a control mode of feedback-controlling of the rotation speed of the driving roller, based on the analysis result of the frequency analysis.

7. The image forming apparatus according to claim 1, wherein
a diameter of the speed detection roller is smaller than a diameter of the driving roller.

8. The image forming apparatus according to claim 1, wherein
the driving roller is a fixing roller that fixes the overprint image onto the recording medium.

9. The image forming apparatus according to claim 8, wherein
the image former is an electrophotographic image former that includes an image bearing member, an endless intermediate transfer belt, and a transfer roller where the intermediate transfer belt is around and which is disposed at a position at which the overprint image is formed onto the recording medium, the image bearing member carrying a toner image, the endless intermediate transfer belt receiving the toner image from the image bearing member.

10. The image forming apparatus according to claim 9, wherein
a conveying force of the transfer roller is smaller than a conveying force of the fixing roller.

11. The image forming apparatus according to claim 9, wherein
the fixing roller is disposed downstream of the transfer roller in the conveyance direction.

12. The image forming apparatus according to claim 9, wherein
the speed detection roller is disposed upstream of the transfer roller in the conveyance direction and outside a housing of the image forming apparatus.

13. The image forming apparatus according to claim 1, wherein
the recording medium is a continuous sheet.
